(19) United States
(12) Patent Application Publication
(10) Pub. No.: US 2015/0095211 A1
(43) Pub. Date: Apr. 2, 2015

(54) SYSTEM AND METHOD FOR PROVIDING LOAN ANALYTICS TO CUSTOMERS

(71) Applicant: CoreLogic Solutions, LLC, Irvine, CA (US)

(72) Inventors: Geoffrey BELL, Irvine, CA (US); Matthias BLUME, Irvine, CA (US); Michael MARON, Irvine, CA (US); Rich PAULSON, Irvine, CA (US)

(73) Assignee: CoreLogic Solutions, LLC, Irvine, CA (US)

(21) Appl. No.: 14/283,494

(22) Filed: May 21, 2014

Related U.S. Application Data
(60) Provisional application No. 61/883,943, filed on Sep. 27, 2013.

(51) Int. Cl. G06Q 40/02

(52) U.S. Cl. CPC G06Q 40/025
USPC 705/38

(57) ABSTRACT

Systems and methods are disclosed that can enable a user to search for real estate properties by specifying search criteria that may exclude personal information. The systems and methods then can subsequently conduct a search for real estate property listings based partly on the specified search criteria and access loans associated with the matched properties. The system and methods then can perform analysis of the loans to identify loan and consumer characteristics and generate an electronic report that includes a representation of the loan and consumer characteristics.

### CROSS-REFERENCE TO RELATED APPLICATIONS

The present application claims the benefit of the earlier filing date of commonly owned U.S. Provisional Patent Application 61/883,943 filed on Sep. 27, 2013, the entire contents of which are hereby incorporated by reference in its entirety.

### TECHNICAL FIELD

Embodiments of this invention relate to methods and systems for providing loan analytics to customers.

### BACKGROUND

The task of locating and evaluating residential real estate properties for purchase is frequently burdensome and time consuming. Typically, the buyer selects a geographic region of interest, and searches sales listings for suitable properties. The buyer may then conduct a financial analysis of each property to assess whether the buyer will be eligible to purchase the property and afford the property. Because these tasks are burdensome, buyers frequently only consider a very small sample of the available properties, and thus fail to consider all purchase options.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to provide loan analytics to customers.

FIG. 2 is a flowchart illustrating a method of providing loan analytics to customers in accordance with an embodiment.

FIG. 3 is a block diagram that schematically illustrates an example of one or more inputs that may be provided in a customer inquiry.

FIG. 4 is a block diagram that schematically illustrates an example of one or more consumer characteristics that may be analyzed in accordance with an embodiment.

FIGS. 5A-C are examples of a report including loan analytics that may be provided to customers in accordance with an embodiment.

### DETAILED DESCRIPTION

Various aspects of the disclosure will now be described with regard to certain examples and embodiments, which are intended to illustrate but not to limit the disclosure.

Computer-based systems and methods are disclosed for providing loan analytics for real estate properties. In some embodiments, the systems and methods can enable users to provide search criteria that optionally excludes personal and to provide loan and consumer characteristics of properties matching the search criteria. In some embodiments, the loan and consumer characteristics of the matched properties based on the search criteria can be outputted graphically in a variety of configurations.

### Overview

In some embodiments, systems and methods can enable a user to search for real estate properties by specifying search criteria that may exclude personal information. The systems and methods subsequently identify properties that match the specified search criteria. The systems and methods then access loan data associated with the match properties and perform analysis of the loan data to identify consumer and loan characteristics. The loan and consumer characteristics may then be provided in an electronic report.

Implementations of the disclosed systems and methods will be described in the context of providing loan analytics for real estate properties. This is for purposes of illustration and is not a limitation. For example, implementations of the disclosed systems and methods can be used to provide loan analytics for commercial property developments such as office complexes, industrial or warehouse complexes, retail and shopping centers, apartment rental complexes, vehicles, equipment, or any other tangible or intangible asset for which loan financing may be obtained.

### Example Customer System

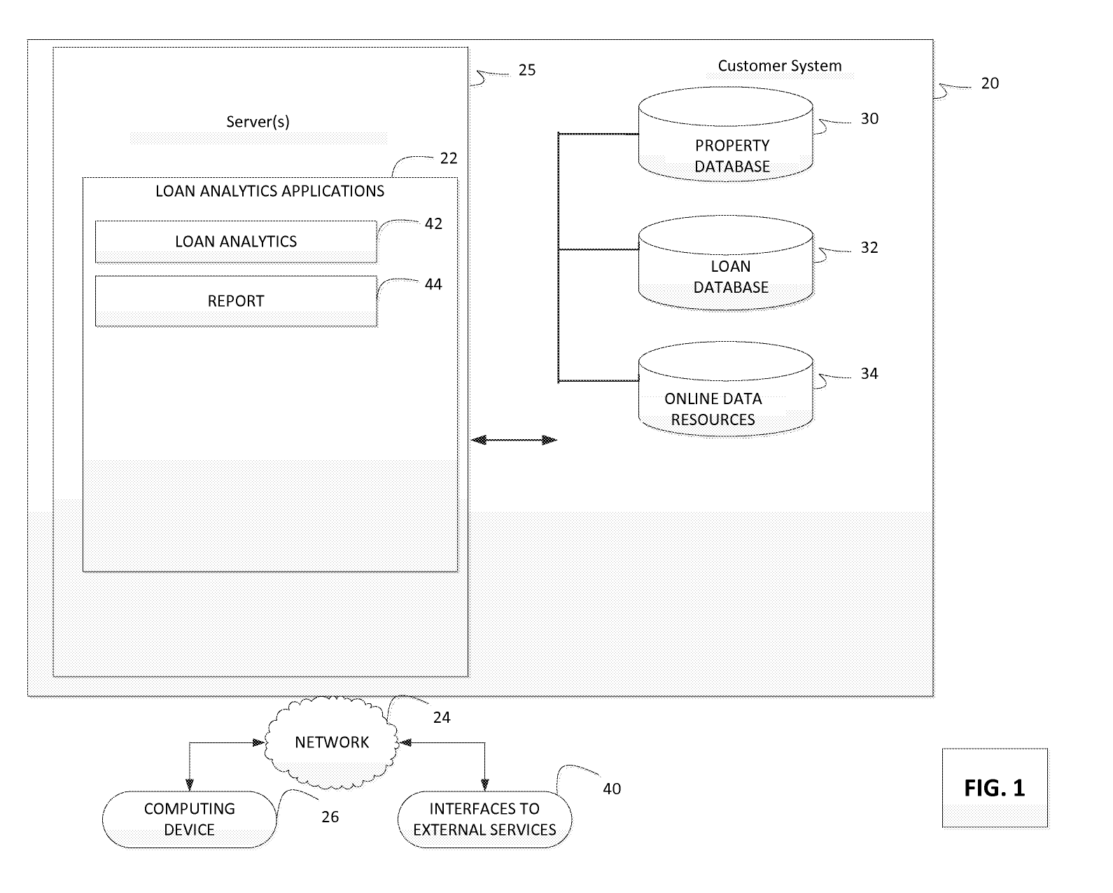

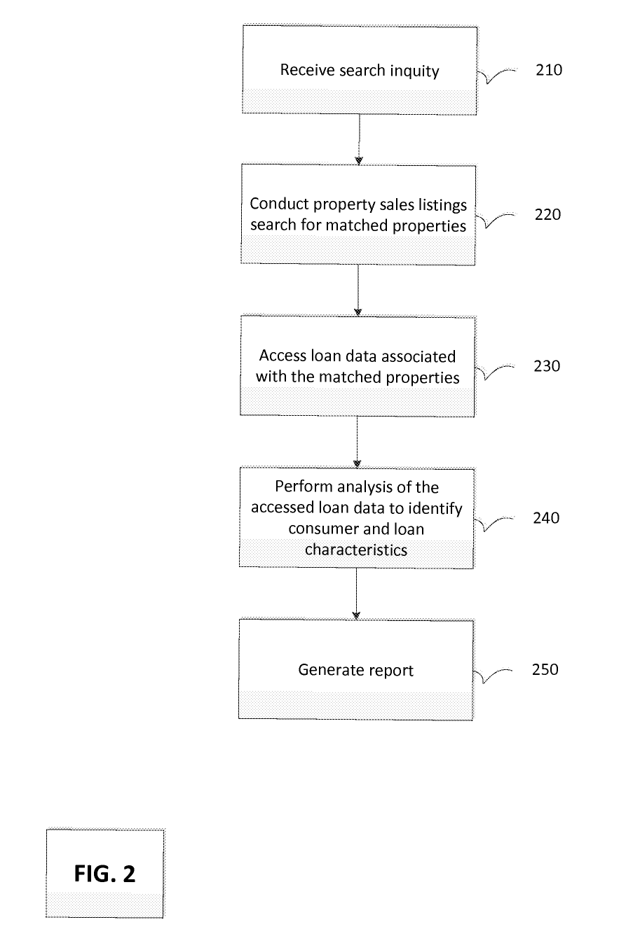

FIG. 1 illustrates a customer system 20 according to one embodiment. The system may be provided by a business entity or “loan analytics provider” that provides various services to its customers for assessing purchase opportunities associated with assets, such as real estate properties. As illustrated, the system includes a set of loan analytics applications 22 that are accessible over a network 24 (such as the Internet) via a computing device 26 (desktop computers, mobile phones, servers, etc.). Typical customers of the system 20 include real estate buyers, real estate investors, real estate agents, financial institutions, or the like.

As illustrated, loan analytics applications 22 use a set of data repositories 30-34 to perform various types of analytics tasks, including tasks associated with loan analytics. In the illustrated embodiment, these data repositories 30-34 include a database of property data 30, a database of loan data 32 (preferably aggregated/contributed from multiple lenders, as described below), and any other online data resources 34. Although depicted as separate databases, some of these data collections may be merged into a single database or distributed across multiple distinct databases. Further, additional databases containing other types of information may be maintained and used by the loan analytics applications 22. As shown in FIG. 1, each loan analytic application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLS) contain data intended for real estate agents, and can be contacted and queried through a network such as the Internet. Such data may then be downloaded for use by embodiments of the present invention. Other examples include retrieving data from databases/websites such as Redfin, Zillow, etc. that allow users to directly post about available properties. Furthermore, property database 30 may contain aggregated data collected from public recorder offices in various counties throughout the United States. This database 30 can include property ownership information and sales transaction histories with buyer and seller names, obtained from recorded land records (grant deeds, trust deeds, mortgages, other liens, etc.). In one embodiment, the loan analytics provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 is preferably updated on a daily or near-daily basis so that it closely reflects the current ownership statuses of properties throughout the United States. In one implementation, the database 30 covers 97% of the sales transactions from over 2,535 counties.

The database of loan data 32 preferably includes aggregated mortgage loan data collected by lenders from mortgage loan applications of borrowers. The loan analytics provider may obtain the loan application in various ways. For example, the mortgage servicers may provide the loan characteristics and performance information into a consortium database so that mortgage investors can properly price their portfolios. As another example, lenders and other users of the customer system 20 may supply such data to the system 20 in the course of using the customer applications 22. The users may supply such data according to an agreement under which the loan analytics provider and system can persistently store the data and re-use it for generating summarized analytics to provide to the same and/or other users. Such a database is maintained by CoreLogic, Inc. As another example, the loan analytics provider may obtain such loan data through partnership agreements. As a further example, the loan analytics provider may obtain such loan data from government-sponsored enterprises, such as Fannie Mae or US government databases, such as the Home Mortgage Disclosure Act (NMDA) database. As yet another example, the loan analytics provider may itself be a mortgage lender, in which case the loan data may include data regarding its own loans. Loan data obtained by the loan analytics provider from lenders is referred to herein as “contributed loan data.”

Current data for pricing loans can be obtained directly from one or more mortgage lenders, from mortgage pricing engine such as Mortech, PriceMyLoan, Loansifter, or Priceweaver, or from sources that publish the factors that affect mortgage pricing including prime rate, 10 year bond interest rate, or 30 year bond interest rate such as the US government or the Wall Street Journal.

Online data resources 34 include any other online resources that provide available loan data for real estate properties. Examples of online data resources 34 containing loan data include servers owned, operated, or affiliated with local governments, financial institutions, or any other server or service containing loan data.

As further shown in FIG. 1, the system 20 may also include one or interfaces 40 to other (externally hosted) services and databases. For example, the system may include APIs or other interfaces for retrieving data from LexisNexis, Merlin, MERS, particular real estate companies, government agencies, and other types of entities.

As further shown in FIG. 1, the loan analytics applications 22 include a “loan analytics” application or application component 42 (hereinafter “application 42”). As explained below, this application or component 44 performs statistical analysis on the collected data.

The analytics applications 22 further include a “report” application or application component 44 (hereinafter “application 44”). As explained below, this application or component 44 generates reports based on the loan analytics.

### Example Customer Acquisitions Process

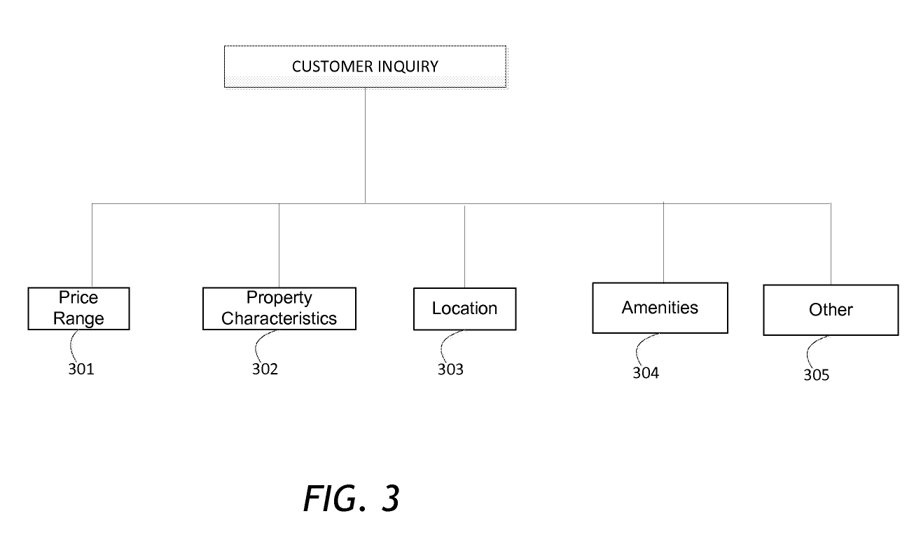

FIG. 2 illustrates one embodiment of an automated process that may be used by the loan analytics application or application component 42 to perform statistical analysis on the collected data. As depicted by block 210 of FIG. 2, the application 42 initially receives a search inquiry as submitted by the computing device 26 via the network 24. The user of computing device 26 may submit the search inquiry via a web page, a web services call, a mobile application, or any other appropriate interface. The submission may either be manual (e.g., a user submits a web form) or automated (e.g., a customer's computer system generates a web service or other type of call). In a preferred embodiment, the search inquiry is from a user interested in purchasing a real estate property. The search inquiry may be based on an actual property the user is interested in purchasing or may be a general search inquiry that is not linked to a property. In one embodiment, the user does not provide any personal information in the search inquiry. FIG. 3, by way of example, illustrates the types of information that can be provided by the potential customer in the search inquiry. As illustrated, the customer may provide a price range 301, property characteristics 302, a location 303, amenities 304, and any other criteria 305. The search inquiry can specify characteristics of available properties that may be of interest to the customer (e.g., selecting available properties in MLS systems) or characteristics or properties desired by the customer (e.g., general and independent of available properties). As illustrated, the search inquiry relates to characteristics or properties of interest or desired but does not include characteristics of the customer.

As shown in block 220 of FIG. 2, the application 42 then conducts a search for addresses associated with the received search inquiry. In the preferred embodiment, this task includes a search of the database of property data 30 (FIG. 1). As will be apparent, data sources other than those identified above may additionally or alternatively be used to conduct the search in block 220. For example, online websites, MLS systems, etc. can be used to obtain address information. Thus, the particular types of data sources discussed above are not critical.

As shown in block 230 of FIG. 2, the application 42 then accesses loan data associated with the matched properties and/or similar properties. In the preferred embodiment, this task includes a search of the database of loan data 32 (FIG. 1). Application 42 collects the loan data associated for the properties that match the search inquiry of the customer.

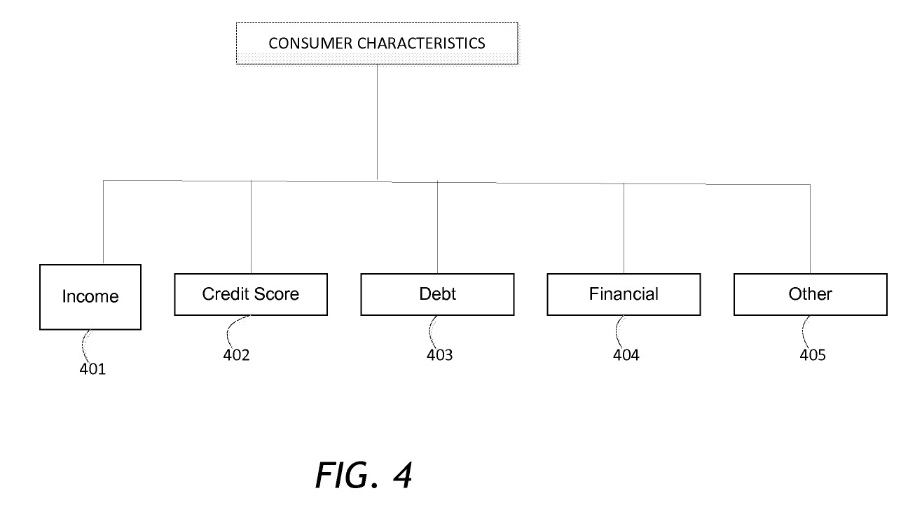

Subsequently, as shown in block 240 of FIG. 2, the application 42 then performs analysis of the collected loan data to identify consumer and loan characteristics associated with the collected loan data. Application 42 performs statistical analysis on the collected loan data to identify characteristics of the consumers and loan products associated with previous loans for properties that are of interest to the customer. Identifying consumer and loan characteristics can then be provided to the customer to enable the customer to have an idea of what financing has been used for properties of interest and what financing criteria the customer may have to meet to be eligible for purchasing a product of interest. An advantage of embodiments of the present invention is that the customer can determine financing criteria and eligibility without having to provide personal information to the loan analytics system 20. Another advantage of embodiments of the present invention is that the customer can determine financing criteria and eligibility without making a commitment. In some embodiments, the collected loan data that is analyzed may be filtered prior to analysis. For example, only loans that have closed in the previous three months, that have included jumbo loans, that have included fixed rates, that are located in a geographic area associated with the customer, are associated with a specific financial institution, etc. may be analyzed. The filtering criteria may be specified by the customer, loan analytics provider 20, or any other entity. FIG. 4 illustrated examples of consumer characteristics that may be identified by application 42 by performing statistical analysis on the collected loan data. As illustrated, application 42 may identify the income 401 of the consumers of the loans of interest, the credit score 402 of the consumers of the loans of interest, the debt 403 (e.g., overall debt, debt-to-income ratio, types of debt, duration of debt, etc.) of the consumers of interest, financial 404 (total savings, total assets, risk metrics, etc.) of the consumers of interest, and any other characteristics of interest 405. In one embodiment, application 42 may calculate aggregate characteristics associated with the consumer characteristics. In other embodiments, application 42 may determine the distribution of the consumer characteristics which can be provided to the customer to enable the customer to understand the likelihood of eligibility for a loan to be provided to the customer. Examples of loan characteristics that may be identified by application 42 by performing statistical analysis on the collected loan data include down payment amount, ratio of down payment to purchase price, loan-to-value ratio, combined loan-to-value ratio, loan program (e.g., conforming, FHA, jumbo), interest rate, loan terms, loan duration, whether mortgage insurance is present, and whether the loan is for an owner-occupied or rental property etc. A variety of other statistical characteristics and metrics may be determined by the application 42.

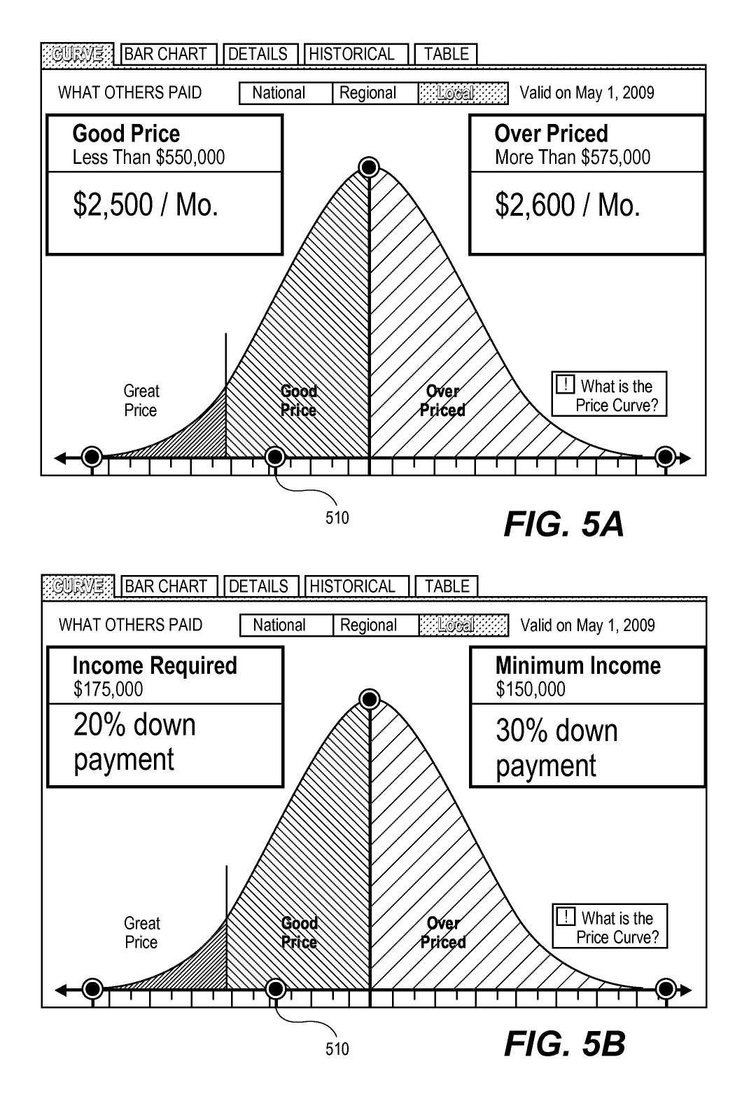

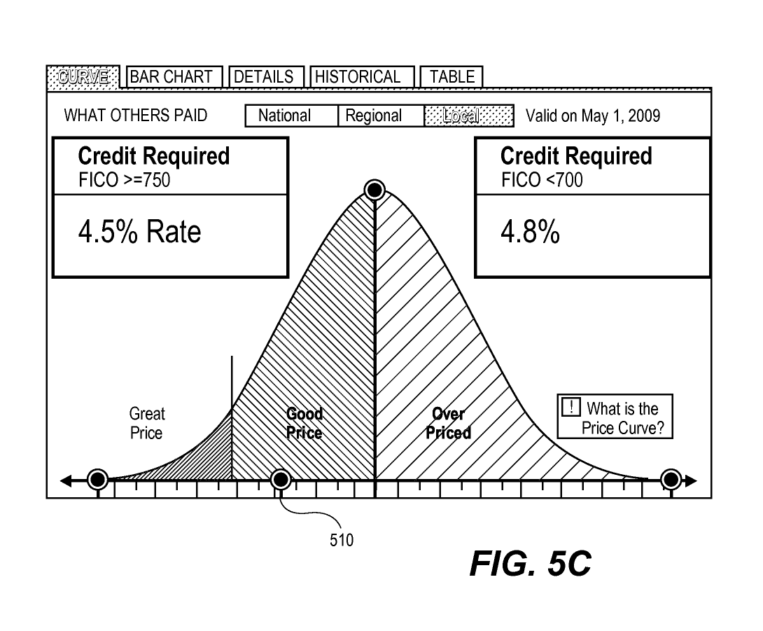

As shown in block 250, the application 44 generates a report based on the analysis described above. The report may then be provided to the customer. The results of the preceding steps may be incorporated into one or more electronic reports in any format desired. In some cases, the auto-generated reports may be manually reviewed and modified by human personnel before they are made available to the customer. FIG. 5 illustrates examples of reports that may be generated. FIG. 5A illustrates a report that illustrates the distribution of loan terms that consumers have received for properties that matched the customer inquiry. FIG. 5B illustrates an example of the distribution of income for consumers associated with the properties of interest. FIG. 5C illustrates the distribution of credit scores of consumers associated with properties of interest. The reports in FIG. 5 are only examples and a variety of different reports including a variety of characteristics may be generated in embodiments of the present invention. In some embodiments, the reports may be interactive in that the customer may provide some personal information to determine the likelihood of obtaining a loan based on the statistical analysis performed. For example, the customer may provide his/her income and application 44 may update the reports of FIG. 5 to indicate where in the distribution the customer falls or may update the distribution curves to represent only those consumers (and their loans) who are similar to the customer based on the provided information. As illustrated in FIG. 5, in some embodiments, the customer may be provided a slider 510 that the customer can interact with to provide personal information. For instance, the customer may interact with the slider 510 in FIG. 5B to indicate the customer's income. Based on the customer input, application 44 may update the reports in FIG. 5 to indicate where in the illustrated distributions the customer may have to fall to be eligible for a loan. For example, in FIG. 5B, if the customer's income was $160,000, the reports in FIG. 5B may be updated to indicated that the customer may be required to put down 25% and FIG. 5C updated to show that the customer may need a FICO score of 750 or higher to receive a 4.6% rate. Similar adjustments can also be made to FIG. 5A. For example, after reviewing the reports of FIG. 5, the customer may change the search inquiry to indicate a lower/higher price by sliding the slider in FIG. 5A. Application 44 may then update the reports of FIG. 5 based on the customer's selection. A variety of different inputs and outputs may be provided in embodiments of the present invention.

In some embodiments, aggregate characteristics and distributions of characteristics may be calculated based on a set of properties that are similar to the property or properties of interest that are available for sale based on searching the property listing data (the subject properties). One way to select the similar properties is based on a fixed set of rules. For example, for a particular subject property, all properties whose sale amount is within 20% of the listed price of the subject property, whose living area is within 20% of the living area of the subject property, that sold within the last three months, and that are less than 2 miles from the subject property are included as similar properties. Another way to select the similar properties is based on adaptive comparable property selection logic. If many similar properties are found, the selection criteria are made more specific in order to return only the most similar properties, whereas if few similar properties are found, the selection criteria are made less specific to acquire an adequately large sample of similar properties.

In some embodiments, if the customer has provided information about himself or about the loan he is interested in, these parameters can be used in selecting the similar properties. For example, the customer has indicated interest in an FHA mortgage, the set of similar properties can be refined to include only properties purchased with an FHA mortgage. If the customer has indicated a personal income, the set of similar properties can be refined to include only properties purchased by persons with an income within 20% of the customers stated income.

Once a set of similar properties has been selected, loan characteristics, consumer characteristics, and property characteristics can be aggregated from the set, and distributions of loan characteristics, consumer characteristics, and property characteristics can be computed. For example, the mean, standard deviation, median, or mode of the loan to value ratio may be computed, and these parameters can be used to graphically represent the distribution of the loan-to-value. In some cases, it may be preferable to compute a weighted average, where the weight is based on the degree of similarity of the comparable property to the subject property.

In some cases, it may be desirable to model current values based on historical and current data. For example, the set of similar properties may include sales from three months ago, six months ago, one year ago, or three years ago. In particular, if a data set is out of date or provided only with a long temporal lag, such as HMDA data, all of the comparable property transaction data may be 18 months or two years old. However, over this period of time, interest rates and underwriting criteria may have changed. The historical values can be adjusted to the current point in time based on a statistical model that represents the relationship between historical parameter values and parameter values that are known at the present time. For example, if underwriting criteria are loosened over time, allowing a consumer with a worse credit score to obtain favorable loan pricing in 2014 versus 2013, a statistical model may be built where the target value is the FICO score and the independent variables include the number of days since the purchase transaction and various loan pricing parameters. Such a statistical model may be built using regression techniques such as linear regression, regression trees, or neural networks.

### CONCLUSION

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the loan analytics module 42, and report module 44, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-34, relational databases and flat file systems that use magnetic disk storage and/or solid state RAM. Some or all of the components shown in FIG. 1, such as those that are part of the Customer System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A computer system, comprising:
a server system comprising one or more computing devices, said server system providing a user interface for initiating a search for real estate properties, said user interface including functionality for specifying property search criteria that does not include any personal information associated with a user providing the search criteria; and
a property locator service that runs on the server system, said property locator service responsive to a submission of the property search criteria via the user interface by performing a process that comprises:
conducting a search of real estate property sales listings, said search constrained at least partly based on the specified search criteria;
for each of a plurality of real estate properties located in the search of property sales listings, accessing loan data associated with the real estate property;
performing statistical analysis of the accessed loan data to identify aggregate consumer and loan characteristics; and
generating an electronic report that includes a representation of the identified consumer and loan characteristics.

2. The system of claim 1, wherein the consumer characteristics comprise at least one of a credit score, an income, or a debt.

3. The system of claim 1, wherein the process performed by the property locator service further comprises receiving personal information associated with the user and updating the electronic report to include the personal information.

4. The system of claim 1, wherein the loan characteristics comprise at least one of a type of loan, a loan-to-value ratio, or a down payment amount.

5. The system of claim 1, wherein the accessed loan data is filtered prior to performing the statistical analysis.

6. The system of claim 5, wherein the accessed loan data is filtered based at least in part on the type of loan or location associated with the loan.

7. The system of claim 1, wherein the process performed by the property locator service further comprises identifying real estate properties that are similar to the plurality of real estate properties located in the search of property sales listings and accessing the loan data associated with the identified real estate properties for performing the statistical analysis.

8. The system of claim 7, wherein the real estate properties that re similar to the plurality of real estate properties located in the search of property sales listings are identified based on one or more rules.

9. The system of claim 3, wherein the one or more rules are based at least in part on the sale price, gross living area, or distance of the identified real estate properties.

10. The system of claim 1, wherein the loan or consumer characteristics are adjusted prior to generating the electronic report to account for changes in underwriting criteria.

11. The system of claim 1, wherein the plurality of real estate properties located in the search of property sales listings comprise at least 1,000 real estate properties.

12. A non-transitory computer readable storage medium comprising instructions which, when executed by a computer system that includes a data processor and is connected to at least one data repository, perform a method comprising:
(a) receiving, by the computer system through a network communication channel, a user inquiry that includes search criteria that does not include any personal information associated with a user providing the search criteria;
(b) conducting, by the data processor, a search of real estate property sales listings, said search constrained at least partly based on the specified search criteria;
(c) for each of a plurality of real estate properties located in the search of property sales listings, accessing, by the data processor, loan data associated with the real estate property;
(e) performing, by the data processor, statistical analysis of the accessed loan data to identify consumer and loan characteristics; and
(f) generating, by the data processor, an electronic report that includes a representation of the identified consumer and loan characteristics.

13. The non-transitory computer readable storage medium of claim 12, wherein the consumer and loan characteristics comprise a distribution of loan and consumer characteristics.

14. The non-transitory computer readable storage medium of claim 12, wherein the consumer and loan characteristics comprises aggregate loan and consumer characteristics.

15. The non-transitory computer readable storage medium of claim 12, wherein the consumer characteristics comprise at least one of a credit score, an income, or a debt.

16. The non-transitory computer readable storage medium of claim 12, wherein the method further comprises receiving personal information associated with the user and updating the electronic report to include the personal information.

17. The non-transitory computer readable storage medium of claim 12, wherein the loan characteristics comprise at least one of a type of loan, a loan-to-value ratio, or a down payment amount.

18. The non-transitory computer readable storage medium of claim 12, wherein the accessed loan data is filtered prior to performing the statistical analysis.

19. The non-transitory computer readable storage medium of claim 18, wherein the accessed loan data is filtered based at least in part on the type of loan or location associated with the loan.

20. The non-transitory computer readable storage medium of claim 12, wherein the method further comprises identifying real estate properties that are similar to the plurality of real estate properties located in the search of property sales listings and accessing the loan data associated with the identified real estate properties for performing the statistical analysis.
